(19) United States
(12) Patent Application Publication
(10) Pub. No.: US 2026/0211996 A1
(43) Pub. Date: Jul. 23, 2026

(54) SECURE ORCHESTRATION OF WORKFLOWS WITH IDENTITY PROPAGATION AND LEAST PRIVILEGE

(71) Applicant: International Business Machines Corporation, Armonk, NY (US)

(72) Inventors: Akshar Kaul, Bangalore (IN); Sandeep Nishad, Bangalore (IN); VINAYAKA PANDIT, Bangalore (IN); VENKATRAMAN RAMAKRISHNA, Bangalore (IN); Abhishek Singh, Delhi (IN); MARC P. STOECKLIN, Richterswil (CH)

(21) Appl. No.: 19/027,451

(22) Filed: Jan. 17, 2025

(51) Int. Cl. G06F 21/45; G06F 9/46

(52) U.S. Cl. CPC G06F 21/45; G06F 9/468

(57) ABSTRACT

Mechanisms are provided for minimizing privileges exposed during workflow execution. A trust companion computing system receives, from an orchestration platform, workflow portion(s) of a workflow for performing a task. The workflow portion(s) have one or more entities that invoke tool(s) to perform sub-tasks of the task. For each tool, the trust companion determines a corresponding credential used to invoke the tool to perform an action on secure backend resources. The corresponding credential corresponds to a reduced size set of privileges, less than a superset of privileges, that are used to perform the action. For each tool, the trust companion requests, from one or more identity providers, a token that provides only the credential having the reduced size set of privileges. The trust companion provides the tokens for each tool in the one or more tools to the corresponding entities. The workflow is executed via the entities using the tokens.

### BACKGROUND

The present application relates generally to a data processing apparatus and method and more specifically to a computing tool and computing tool operations/functionality for secure orchestration of workflows with identity propagation and least privilege.

An orchestration platform is a system that integrates multiple applications and services to automate a process or provide real-time data synchronization. An orchestration platform is used for automated configuration, management, and coordination of computer systems, applications, processes, and services. Orchestration helps IT teams to more easily manage complex tasks and workflows.

Agentic frameworks refers to software systems that enable the creation of autonomous agents capable of making decisions and taking actions based on user inputs, data, or pre-programmed rules. An agentic AI platform consists of a large language model (LLM), multiple agents that leverage that LLM, and an orchestration system that can dynamically select and deploy the agents across various applications. These agents may be AI models or may be simple search tools that can quickly look up information in knowledge bases or online, and make decisions.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided that comprises receiving, by a trust companion computing system, from an orchestration platform, one or more workflow portions of a workflow for performing a task. The workflow portions comprise one or more entities that invoke one or more tools to perform sub-tasks of the task. The method further comprises, for each tool in the one or more tools: determining, by the trust companion computing system, a corresponding credential to be used to invoke the tool to perform an action on secure backend resources, where the corresponding credential corresponds to a reduced size set of one or more privileges, less than a superset of privileges, that are used to perform the action; and requesting, by the trust companion computing system, from one or more identity providers, a token that provides only the credential having the reduced size set of one or more privileges. The method further comprises providing, by the trust companion computing system to the one or more entities, the tokens for each tool in the one or more tools. In addition, the method comprises recording, by a secure backend system associated with the one or more tools, tokens used to execute the one or more workflow portions by the one or more tools, for provenance and auditing.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of an agentic framework and orchestration platform in accordance with one illustrative embodiment;

FIG. 2 is an example block diagram of the trusted companion system in accordance with one illustrative embodiment;

FIG. 3 is an example diagram of a distributed data processing system environment in which aspects of the illustrative embodiments may be implemented and at least some of the computer code involved in performing the inventive methods may be executed;

FIG. 4 is a flowchart outlining an example operation of a trusted companion system in accordance with one illustrative embodiment; and

FIG. 5 is a flowchart outlining an example operation for dynamic credential selection in accordance with one illustrative embodiment.

### DETAILED DESCRIPTION

The illustrative embodiments provide a computing tool and computing tool operations/functionality for secure orchestration of workflows with identity propagation and least privilege. The illustrative embodiments operate to minimize the exposure of privileges when invoking tools to perform a workflow. While not necessarily preventing unwanted parties, i.e., adversaries, from gaining access to these privileges, which may be handled by other security mechanisms, the illustrative embodiments limit which privileges the adversary is able to access should they gain access. The limits on privileges are implemented in accordance with privilege security policies that operate to minimize the privilege exposure in one or more ways, such as smallest expiry time, least number of identities used, etc. In this way, if these privileges are accessed by the adversary, the exposure is limited rather than exposing superuser or more expansive sets of privileges.

The description of the illustrative embodiments set forth herein will reference a number of terms that are beneficial to define prior to encountering them in the description. The following are definitions of these terms for ease of understanding:
Credentials: Information (such as usernames, passwords, or certificates) used to verify the identity of a user, system, or application during authentication.
Token: A digital object representing authorization or authentication, often issued temporarily to grant secure access to a resource or service without sharing credentials directly.
Application Programming Interface (API): A set of rules and protocols allowing different software applications to communicate and interact, enabling the integration of functionalities.
Tool: A software utility or application designed to perform specific tasks or provide functionality, often used to enhance productivity or automate processes.
Agent: A specialized language model-based entity within a multi-agent workflow that autonomously performs tasks, collaborates, and communicates with other agents or systems to achieve specific goals, leveraging natural language understanding and generation.
Privilege: The rights or permissions granted to a user, system, or process to perform specific actions or access certain resources within a system.
Scope: It is a way in which the Oauth2 protocol associated privileges to tokens.
Policy: A formal set of rules or guidelines that govern the behavior, access, or operations of systems, users, or applications within an environment.

With these definitions in mind, the illustrative embodiments are directed to providing a computing tool and computing tool operations/functionality directed to improving security of the workflow implemented via an orchestration platform. Whereas much work is being done on improving user interactions with orchestration platforms, there is a need to focus on potential security issues with regard to the privileges provided to tools. As is discussed herein, it has been found that the credentials that are provided to the tools used to implement the workflows may be exposed to an adversary due to the tools being compromised. These exposed credentials can then be misused by the adversary. That is, there is a lack of control by the trusted entities, e.g., the orchestration platform, over the privileges passed to these tools and there is the potential for misuse of credentials that allow more privileges than are strictly needed for a given operation of the tools to be provided to the tools and potentially accessed by adversaries.

Moreover, orchestration platforms currently either use a generic super user credential or a user credential which has all possible privileges when calling tools. If these credentials are compromised, they have potential for heavy misuse due to their wide scope of privilege. There is a lack of end-to-end auditability when generic privileged identities are used in place of specific user identities, such that audit traces are difficult to perform to find what parties may have misused the credentials. Auditing capabilities are important to know who did what after the fact for various types of analysis outside of just forensics. The illustrative embodiments provide a trust companion computing tool and corresponding operations/functionality that addresses these shortcomings in existing orchestration platform based workflow execution frameworks.

Orchestration platforms, as noted above, integrate multiple applications and services to automate a process or provide real-time data synchronization. Orchestration platforms may provide functionality for users to define their own workflows for tasks through an easy to use interface. Alternatively, or in addition, orchestration frameworks may provide automated generation of workflows, such as via one or more artificial intelligence (AI) based mechanisms. The orchestration platform may generate these workflows using skills, which are traditional programs that are coded according to some specification, perform a specific set of tasks, and must be manually reprogrammed if a different behavior (or upgrade) is desired. With the advent of agentic frameworks, orchestration platforms may generate and orchestrate these workflows using agents that act to invoke tools that are used to perform operations on a secure backend to accomplish the tasks of the workflow. An agent is a program designed to perform specific tasks autonomously based on predefined rules and/or AI based learning of patterns. Agents are programs that can learn or adapt over time, to handle changing user input. Agents may be the frontend for language models (LMs) or large language models (LLMs), which learn (i.e., reprogram themselves) over time based on new knowledge and observations. Thus, agents have more “intelligence” than skills in that agents have the ability to learn, adapt, and make decisions autonomously, whereas skills are a predetermined series of algorithmic steps.

It should be appreciated that, whether using skill-based or agent-based workflow execution by an orchestration platform, these agents/skills may be provided by third parties and thus, are not necessarily under the control of the trusted orchestration platform. Similarly, tools that may be invoked by the agents/skills may likewise be out of the control of the trusted orchestration platform. Thus, these elements of the framework present potential security vulnerabilities where an adversary may gain access to credentials and corresponding privileges for performing operations on secure backend resources, e.g., applications, data structures, and the like. The illustrative embodiments minimize exposure of privileges via these security vulnerabilities by limiting the credentials and corresponding privileges used to invoke the tools needed to perform the workflow to only those credentials/privileges needed to perform the specific operation by the tools and thus, adversaries do not gain access to more privileges than what was required by the workflow.

The following description provides examples of embodiments of the present disclosure, and variations and substitutions may be made in other embodiments. Several examples will now be provided to further clarify various aspects of the present disclosure.

Example 1: A method comprising receiving, by a trust companion computing system, from an orchestration platform, a one or more workflow portions of a workflow for performing a task, where the one or more workflow portions comprise one or more entities that invoke one or more tools to perform sub-tasks of the task. The method further comprises for each tool in the one or more tools: determining, by the trust companion computing system, a corresponding credential to be used to invoke the tool to perform an action on secure backend resources, wherein the corresponding credential corresponds to a reduced size set of one or more privileges, less than a superset of privileges, that are used to perform the action; and requesting, by the trust companion computing system, from one or more identity providers, a token that provides only the credential having the reduced size set of one or more privileges. The method also comprises providing, by the trust companion computing system to the one or more entities, the tokens for each tool in the one or more tools. In addition, the method comprises recording, by a secure backend system associated with the one or more tools, tokens used to execute the one or more workflow portions by the one or more tools, for provenance and auditing.

The above limitations advantageously enable minimizing of the credentials used with tools to perform actions as part of a workflow, such that the credentials are only those needed for the tools to perform their corresponding actions. Moreover, the above limitations advantageously enable provenance and auditing to be performed on a more fine-grained level so that individual sources of actions and operations that may be the cause of breaches may be identified rather than shared or super-credentials being utilized which hamper such auditing.

Example 2: The limitations of any of Examples 1 and 3-7, where determining the corresponding credential comprises applying one or more privilege security policies to the workflow, wherein the one or more privilege security policies comprise goals specifying a metric for minimizing exposure of privileges when invoking tools for performing the workflow. The above limitations advantageously allow for controlled obtaining of privileges for use in performing workflows to minimize the privileges that are potentially able to be accessed by adversaries such that if an adversary gains access to the credentials, the scope of the actions they can perform using the stolen credentials is minimized.

Example 3: The limitations of any of Examples 1-2 and 4-7, where the one or more privilege security policies comprises at least one of: a first privilege security policy that minimizes a number of identities of a user used to invoke tools for performing the workflow, a second privilege security policy that minimizes a scope of privileges of the credentials used to invoke tools for performing the workflow, a third privilege security policy that minimizes expiry time of privileges of the credentials used to invoke tools for performing the workflow, or a fourth privilege security policy that maximizes an auditability of logs of actions performed by the tools when performing the workflow. The above limitations advantageously enable various types of control over the scope of privileges that may be utilized when requesting tokens from identity providers for use with tools to perform a workflow. With each of these options, the types of privileges and identities are controlled so that an adversary, even if obtaining access to the tokens, is limited in the types of attacks that they may potentially make on any backend systems.

Example 4: The limitations of any of Examples 1-3 and 5-7, where determining the corresponding credential comprises generating, for each available credential for a user, an exposure score that measures a degree of exposure of privileges associated with the credential, and selecting a credential from the available credentials for the user based on the exposure scores for each available credential for the user. The above limitations advantageously enable the selection of credentials based on a quantitative assessment of the exposure that such credentials may cause with regard to corresponding privileges.

Example 5: The limitations of any of Examples 1~4 and 6-7, where the exposure score is generated based on a function of a plurality of factors and a plurality of weights applied to the plurality of factors, wherein the factors comprise at least one of a number of identities used by the credential, an exposure due to scopes of privileges associated with the credential, an expiry time associated with the credential, or an auditability of the credential. The above limitations advantageously enable a weighted quantitative evaluation of exposure taking into account various factors that contribute to the exposure of privileges.

Example 6: The limitations of any of Examples 1-5 and 7, where the one or more entities execute the workflow using the one or more tools and the tokens provided to the one or more entities. The above limitations advantageously enable the execution of workflows using the tools and a minimized set of privileges that minimize the exposure to potential adversaries.

Example 7: The limitations of any of Examples 1-6 where the one or more entities are language model backed agents that autonomously perform corresponding tasks, leveraging natural language understanding and generation, and which communicate with other language model backed agents in the one or more entities to achieve specific sub-tasks of the workflow. The above limitations advantageously enable the leveraging of artificial intelligence of trained language models to perform operations of a workflow using the limited privileges determined by the mechanisms of the illustrative embodiments.

Example 8: A computer program product comprising one or more computer readable storage media, and program instructions collectively stored on the one or more computer readable storage media, the program instructions comprising instructions configured to cause one or more processors to perform a method according to any one of Examples 1-7. The above limitations advantageously enable a computer program product having program instructions configured to cause one or more processors to perform and realize the advantages described with respect to Examples 1-7.

Example 9: A system comprising one or more processors and one or more computer-readable storage media collectively storing program instructions which, when executed by the one or more processors, are configured to cause the one or more processors to perform a method according to any one of Examples 1-7. The above limitations advantageously enable a system comprising one or more processors to perform and realize the advantages described with respect to Examples 1-7.

The illustrative embodiments will be described herein with regard to an agentic framework type orchestration platform in which agents are called by the orchestration platform to perform the workflow. However, it should be appreciated that the illustrative embodiments are not limited to such. Rather, the illustrative embodiments may be implemented with any orchestration platform that uses skills or agents to orchestrate the execution of workflows.

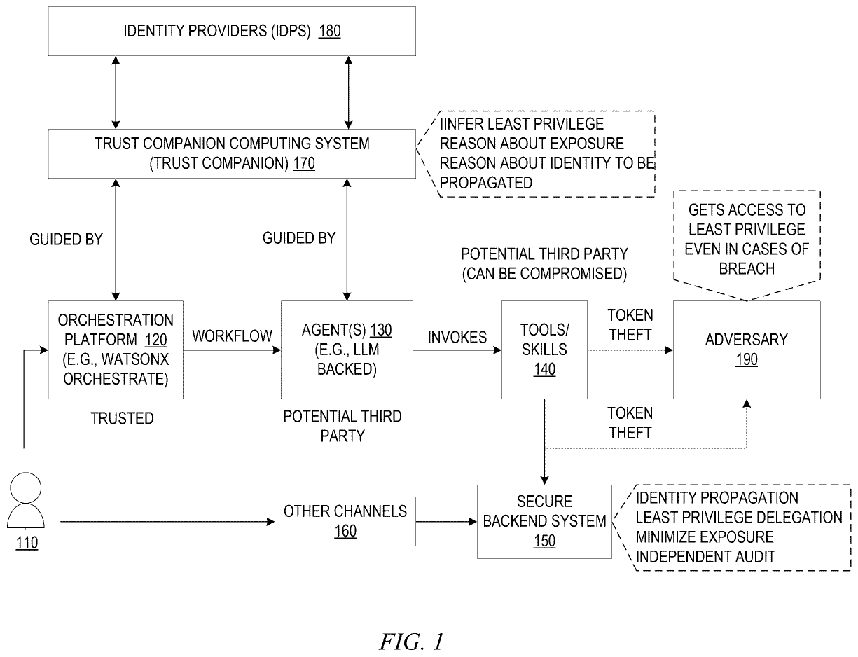

FIG. 1 is an example diagram of an agentic framework and orchestration platform in accordance with one illustrative embodiment. In an agentic framework, if a user wishes to have an operation performed, the user 110 may log onto an orchestration platform 120, such as IBM® WatsonX™ Orchestrate® (WxO) available from International Business Machines (IBM®) Corporation of Armonk, New York, or the like. WxO is a generative artificial intelligence (AI) based orchestration platform that allows a user to generate workflows and automate tasks. Through the orchestration platform 120, workflows may be specified by the user or automatically generated via AI mechanisms based on a user's request to perform a particular operation and other specified parameters. The orchestration platform 120 may implement language models (LMs) and/or large language models (LLMs) to understand a user's prompt input and generate a workflow that meets the requirements of the prompt. For example, a user may input a prompt with a natural language description of the task or operation that they wish to perform via a LM/LLM interface or the like, e.g., “Create a job req for Financial Analyst”. The LM/LLM may interact with the user via responsive prompts, such as “How do you want to create a job requisition?” and build a workflow of the particular agents to use to accomplish the user's requested task.

The workflow generated via the orchestration platform 120, or one or more workflow portions of the workflow, are provided to the agents 130 which may be rule based agents, artificial intelligence computing model based agents, or the like. In one or more illustrative embodiments, the agents may be backed by a LM/LLM. The agents may be provided by third party providers separate from that of the trusted orchestration platform 120 and thus, may be potentially compromised by adversaries 190. Each workflow will generally have more than one agent 130 used to implement corresponding workflow portions of the workflow and perform their corresponding sub-tasks for performing the overall task. As a simplified example, if a user asks the orchestration platform to change their home location to location B, the workflow may indicate that a first agent is called to access the user's account (first workflow portion) and determine what the user's current home location (location A) is, and then call another agent to perform the change of the home location from location A to location B (second workflow portion). Each agent may invoke different tools 140 to accomplish their corresponding sub-tasks. The tools 140 call applications via application programming interfaces (APIs), access data, and perform actions on the secure backend system 150, e.g., an employee management system, to accomplish the sub-tasks and the task of the workflow as a whole.

As illustrated in FIG. 1, as the agents 130 and tools 140 are potentially provided by third party providers, and thus are not necessarily trusted by the trusted orchestration platform, they present potential security vulnerabilities that may be exploited by adversaries 190 to gain access to credentials and their privileges to perform unwanted actions on the secure backend system 150. As a result, the adversaries 190 may access the tools 140, or the communications with the tools 140 over the data network(s), and thereby steal the tokens being used with and by the tools 140. Tokens may be leaked via misconfiguration of tools 140, insecure communication with the secure backend system 150, such as over hypertext transfer protocol (HTTP), logging credentials to log files at the secure backend system 150, insider threats, tokens being stored in local memory, and the like. The tokens specify the credentials and privileges to the tools 140 that are needed for the tools 140 to perform their actions on the secure backend system 150. As a result, the adversaries 190 will then have access to whichever credentials and privileges are used with the tools 140 and will be able to perform actions on the secure backend system 150 in an unauthorized manner using those stolen credentials and privileges.

For example, assume that the orchestration platform 120 is the IBM® WatsonX™ Orchestrate® (WxO) platform and that the tools 140, for example, include a Python tool that uses an API provided by the secure backend system 150, which is an employee management system, to access and update information in the secure backend system 150 (employee management system). The agent 130 may be a specialized LLM backed agent that handles tasks related to employee information as an example. With this arrangement, assume that a user wants to change his/her work location in their employee management system from Location A to Location B. The user logs into the WxO platform 120 and provides a prompt in natural language that he/she wants to change his/her work location from Location A to Location B. The WxO platform 120 processes the prompt and decides that an LLM backed agent 130 that specializes on the employee management system 150 should be used. The agent 130 is called and appropriate information is passed to it. The agent then uses the Python Tool 140 to update the location in the secure backend system 150. However, during this process, the adversary 190 is able to steal the tokens used by the Python Tool 140 to perform the update of the location in the secure backend system 150 and thus, may gain access to the secure backend system 150 by performing unauthorized operations on the secure backend system 150 using the stolen credentials.

Users 110 that log on to the orchestration platform 120 have a set of credentials associated with those users 110 for a set of one or more identities of the user. For example, a user may have an individual identity and one or more group identities, e.g., an individual identity of “John Doe”, and a group identity of “Human Resources”. Each identity may have one or more associated credentials and each credential may have an associated set of privileges, or scope of privileges, and these privileges may have various attributes, e.g., expiry time and the like. These identities and credentials may be provided by one or more identity providers (IDPs) 180. The orchestration platform 120, in response to a user logon by user 110, retrieves all the credentials and privileges associated with all the identities of that user 110 since the orchestration platform 120 does not know a priori what tasks that the user 110 will ask the orchestration platform 120 to perform. The orchestration platform 120 also does not know what credentials and privileges the agents 130 may need and thus, provides all the credentials and privileges to the agents 130 or provides a superuser credential to the agents 130 which provides all privileges and is not tied specifically to the particular user 110. Thus, there is a tendency for the agents 130 to be provided with more credentials and privileges than are required for them to perform their sub-tasks, and there is a tendency for the agents to pass along this superset of credentials and privileges to the tools 140 that they invoke to perform the sub-tasks. As a result, an adversary 190 that gains access to a tool 140, or communications between the agents 130 and the tools 140 which contain the tokens having the credentials and privileges, may obtain all the credentials and privileges for a user 110 and may perform unauthorized and unwanted actions on the secure backend system 150.

In addition, it should be appreciated that it is the changes that are carried out at the secure backend system 150 that are of primary concern and interest from the perspective of the workflow processes. This secure backend system 150 is not only accessed via the orchestration platform driven path of elements 120-140, but may be accessed through other paths and channels 160, e.g., an employee management system website through which employees access and update the information in the secure backend system 150 (e.g., an employee management system), that can likewise make changes to the secure backend system 150. For example, the other paths and channels 160 may be connections to the secure backend system 150 through other user interfaces that are not provided via the orchestration platform 120. Thus, there is a need to be able to provide an independent audit capability, independent of the orchestration platform 120, at the secure backend system 150 to capture not only the identities and credentials used by tools 140 to perform actions on the secure backend system 150, but also identities and credentials used via these other channels 160 to perform actions on the secure backend system 150.

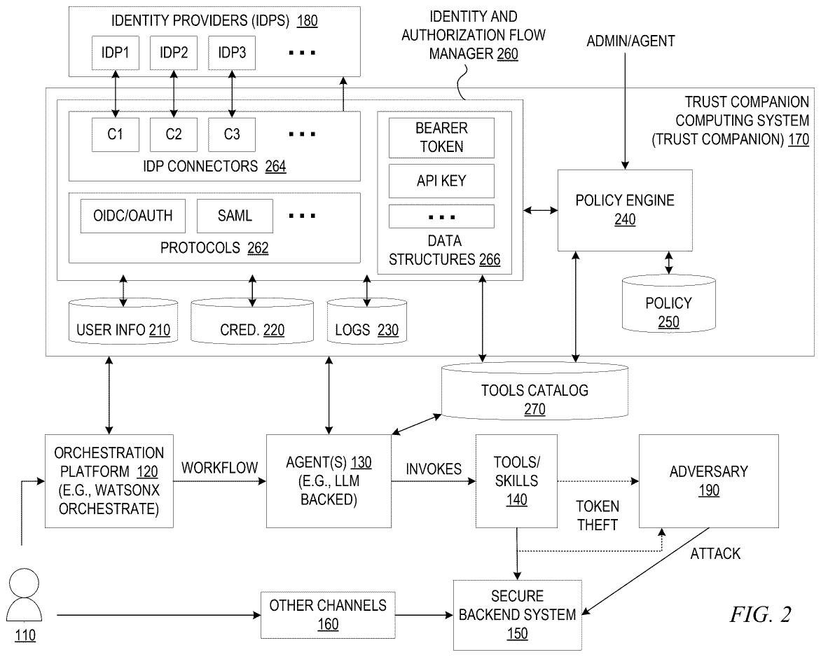

As shown in FIG. 1, in accordance with the illustrative embodiments, the orchestration platform 120 driven path comprising elements 120-140 is augmented to include a trust companion computing system 170 (or simply “trust companion” 170 hereafter). The orchestration platform 120 and agents 130 operate in conjunction with the trust companion 170 which operates to determine the identities and privileges that should be used to accomplish a workflow for a task requested by a user 110, while minimizing exposure of these identities and privileges to adversaries 190. The trust companion 170 operates with identity providers (IDPs) 180 to obtain the tokens for the minimized credentials and privileges in accordance with one or more privilege security policies which specify how to minimize the exposure of privileges when performing a workflow. The trust companion 170 comprises logic and data structures, as will be described hereafter with regard to FIG. 2, to interact with a plurality of different IDPs 180 using a variety of protocols, e.g., OIDC/Oauth, SAML, and the like, as well as various data structures that these protocols rely on. The trust companion 170 further comprising databases of user information, credentials, and privilege security policies, and provides a logging capability to log the events occurring with regard to the trust companion 170 which includes the orchestration platform 120 and agent 130 requests for tokens to implement workflows using the tools 140.

When an orchestration platform 120 receives a logon from a user 110, the orchestration platform 120 will interact with the trust companion 170 to obtain that user's information from a user information registry and correlate that information with a credentials registry to obtain a superset of credentials that comprises all the credentials (comprising the privileges) for all the identities used by that user (a user can have more than one identity that they use to access the secure backend system 150, e.g., individual identity, group identities, and the like. That is, the orchestration platform 120 interacts with the trust companion (TC) 170 to verify user logins to tools and provide all possible access. Thereafter, agents will interact with the trust companion 170 and obtain privilege tokens. Additionally, the orchestration platform 120 can use the trust companion 170 when the agent/too is not capable of interacting with the trust companion 170, in which case the orchestration platform 120 will obtain the tokens from the trust companion 170 and pass them to the agents.

In addition, the trust companion 170 may have a logged history of interactions with the orchestration platform 120 for this user which may be a history for a current session or may be a cross-session history. This history information may be used to make decisions as to what identities to use for a user 110, what credentials to use, and the like, based on previous decisions and interactions performed by the orchestration platform 120 and agents 130 with regard to workflows for this user 110.

As noted previously, the orchestration platform 120 is used to generate a workflow for a task specified by the user 110. The orchestration platform 120 provides the workflow generated via the orchestration platform 120, either manually by a user 110 or automatically by the orchestration platform 120 itself, to the agents 130 which operate to execute the workflow. The agents 130, when they need to invoke a tool 140, interact with the trust companion 170 to request the tokens that they should use to perform the sub-tasks of the workflow. The trust companion 170 automatically determines which of the user's identities and credentials are needed to perform the sub-task, and interacts with the IDPs 180 to obtain the necessary tokens having those credentials (and privileges). The determination of which identities and credentials to use may be performed in accordance with one or more applicable privilege security policies which operate to minimize exposure of privileges when invoking tools 140 to perform operations on the secure backend system 150.

The trust companion 170 then provides those tokens to the agents 130 which may then use those tokens to invoke the tools 140 needed to perform the sub-task on the secure backend system 150. Thus, should an adversary 190 gain access to a tool 140 and thus, the tokens provided to that tool 140, the adversary 190 will not be able to access a superset of privileges, but instead will only be able to access the limited privileges corresponding to the individual tokens needed to perform the sub-task by the invoked tool 140. Hence, while the adversary 190 may still gain access to privileges, the exposure of privileges is minimized.

For example, assume that the orchestration platform 120 is used to create a workflow for updating the salaries of employees in an organization. The workflow may be provided to an agent who then invokes a first tool for generating a report of employees and their salaries, and a second tool to update the salaries of one or more of the employees. Without the trust companion 170 of the illustrative embodiments, the orchestration platform 120 would simply send the superset of credentials/privileges to the agent 130 who would then send that same superset to the tools 140 and thus, an adversary would be able to have access to the entire superset of privileges. However, with the trust companion 170, the trust companion 170 will determine that the first tool only needs a read privilege in order to read the information from the employee database and the second tool only needs a write privilege as it only needs to write to the employee database. These limited tokens are then obtained by the trust companion 170 from the IDPs 180 and only those limited tokens are provided to the agent for use with the first and second tools. As a result, if an adversary 190 has access to only the first tool, the only privileges that the adversary will be able to obtain is the limited token for read access. If the adversary 190 has access to only the second tool, the adversary 190 will only have access to the write privilege limited token. Even if the adversary 190 has access to both the first and second tools, while the adversary 190 may be able to access the limited tokens for read and write access, the adversary 190 still will not have access to the superset of privileges and thus, will not have other privileges beyond the read and write access privileges.

With regard to identities used, and auditing capabilities, the trust companion 170 may look to the history information to reason as to which identity, and corresponding sets of credentials (privileges), should be used to access the agents 130 and tools 140, and ultimately perform actions on the secure backend system 150. For example, if a user has previously during a session used a group identifier, then that group identifier may need to be used for subsequent steps of the workflow. This determination is made by the trust companion 170 on behalf of the agents 130 because each individual agent 130 does not know the overall workflow or the identities used by other agents in the workflow. Thus, the trust companion uses the history information to determine which identities are appropriate to complete the workflow. This may include looking at previous invocations of the same agents by workflows for this same user over previous sessions or within the current session. The reasoning performed by the trust companion 170 seeks to minimize exposure of credentials/privileges and thus, the reasoning will look for identities that provide the least exposure while taking into consideration the previous history of identity usage with the agents 130 for implementing workflows for this user 110.

This further improves audit data storage at the secure backend system 150 since the logging of actions performed on the secure backend system 150 will include information about the identities used, credentials used, and the actions performed. In various deployments, the tools are configured to use a single access token for all the interactions with the backend systems. This access token is usually associated with a superuser. As a result, the backend system has no knowledge of the user 110 who initiated the action. This hampers the audit of the backend system. While users 110 may wish to utilize generalized group level or functional level identities to perform actions, and these group level or functional level identities are not generally able to be correlated with a single user, the trust companion 170 minimizes the use of such group level or functional level identities in an effort to minimize exposure of credentials/privileges. Thus, the logs stored at the secure backend system 150 associated with the tools used to perform portions of the workflow will have an increase in instances of more specific identities and credentials/privileges used to perform the actions on the secure backend system 150.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides a trusted companion computing system that operates to automatically and autonomously determine the particular identities and credentials that should be used by agents to invoke tools to execute a workflow of an orchestration platform, with the aim of minimizing exposure of privileges to the tools which may be compromised by adversaries. The improved computing tool implements mechanism and functionality, such as the trust companion computing system, which cannot be practically performed by human beings either outside of, or with the assistance of, a technical environment, such as a mental process or the like. The improved computing tool provides a practical application of the methodology at least in that the improved computing tool is able to execute workflows while minimizing exposure of privileges to tools and potentially adversaries that have gained access to these tools.

FIG. 2 is an example block diagram of the trusted companion system in accordance with one illustrative embodiment. The operational components shown in FIG. 2 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., search queries, and the resulting output may aid human beings. The invention is specifically directed to the automatically operating computer components directed to improving the way that workflows are executed using agents/skills and invoked tools, where the improvements are to the security of the workflow execution with regard to minimizing exposure of privileges which may be stolen by adversaries. The improvements include a trust companion that performs operations automatically and autonomously to determine which identities to use and which privileges are needed, and to interface with identity providers (IDPs) to obtain tokens that contain only the needed credentials/privileges for the particular sub-tasks for which tools are being invoked. These automatic and autonomous operations cannot be practically performed by human beings as a mental process and are not directed to organizing any human activity.

As shown in FIG. 2 (where elements similar to those of FIG. 1 are shown with similar reference numerals), the trust companion 170 comprises a user information registry 210, a credentials registry 220, a logging database 230, a policy engine 240 and privileges security policy registry 250, and an identity and authorization flow manager 260. The trust companion 170 may access information about the various tools 140 from the tools catalog 270 and may interact with one or more identity providers (IDPs) 180. The user information registry 210 maintains the information about users that are registered with the orchestration platform 120 and their identities. These are mapped to credential stored in the credentials registry 220 such that when a user logs onto the orchestration platform 120, their user information with registered identities are retrieved from the user information registry 210 and the corresponding credentials are retrieved from the credentials registry 220. As the orchestration platform 120 is a trusted entity, it has access to all of these identities and credentials/privileges for the user 110.

The logging database 230 logs activities occurring with regard to the trust companion 170, which includes the historical results of decisions made by the trust companion 170 regarding which identities, credentials, and privileges are selected by the trust companion 170 for workflows and particular agents 130 implementing the workflows using tools 140. The logging database 230 may comprise interface logic for interfacing with the identity and authorization flow manager 260 to capture this historical information and maintain a log in the logging database 230 of this history, which may be for the current session, and possible previous sessions, with the user 110.

The identity and authorization flow manager 260 handles all communication with the IDPs 180 and comprises the protocol handlers 262 and IDP connection interfaces 264 to communicate with the various IDPs 180. In addition, the ID and authorization flow manager 260 stores the data structures 266 needed to utilize the protocol handlers 262 for communicating with the IDPs 180 via the IDP connections 264, e.g., the protocols may rely on bearer token, API key, authorization manager tokens, or the like, for communication with the IDPs 180. In this way, the orchestration platform 120 and agents 130 do not need to know how to communicate with the IDPs 180 to obtain the necessary credentials for performing actions on the secure backend system 150 and instead all of this is handled automatically by the trust companion 170 using the identity and authorization flow manager 260. Moreover, the identity and authorization flow manager 260 is extensible by adding new protocol handlers 262, connections 264, and data structures 266 to handle new IDPs 180 as they are added to the system.

The tools catalog 270 provides all the information of the tools 140 that are available to be used by agents 130 to perform operations for completing a workflow, i.e., for performing sub-tasks of a given task of the workflow. The tools catalog 270 stores for each available tool 140, information specifying the types of functionality the tool provides, APIs used, the scope of privileges that are needed for invoking the functionality of that tool and the APIs, and the like. This information is used by both the agents 130 to identify which tools 140 to invoke, as well as the trust companion 170 when determining, by the policy engine 240, what privilege security policies are applicable, and by the identity and authorization flow manager 260, which tokens to request from the IDPs 180 based on the application of the privilege security policies by the policy engine 240.

The policy engine 240 comprises the intelligent computing logic for selecting identities of users and the credentials with corresponding privileges to use in accordance with privilege security policies in the privileges security policy registry 250. The policy engine 240 processes information from the tools catalog 270 as well as the workflow from the orchestration platform 120 and the information from the agents 130 regarding the tools 140 that they will be invoking to perform the sub-tasks of the workflow. The policy engine 240 retrieves the privilege security policies from the privileges security policy registry 250 that are applicable to the workflow and applies the retrieved privilege security policies to the workflow information, e.g., which agents 130 and tools 140 are needed to perform the sub-tasks of the workflow, what privileges those agents 130/tools 140 need to perform those sub-tasks, and the like.

A policy is a set of rules that should be followed. In the context of this description, the policies are maintained (created, updated and deleted) by authorized personnel, e.g., system administrators, who determine how they want to organize their policies. The policies can be associated with a group of users (or based on some properties of the users), may be associated with agents (or their properties), or may be associated with tools (or their properties). The policies can even be global, i.e., they apply to all interactions, or may be specific to particular interactions. This association is defined with each policy. Based on the policy organization, Policy engine 240 can retrieve the policies that are applicable to the current workflow (which may include more than one policy). Then, based on the policy priority, one or more policies are shortlisted to be applied from this retrieved list. The rules defined in these shortlisted policies are then used by the policy engine 240.

The policy engine 240 may access the historical information in the logging database 230 to identify previous invocations of agents/tools in the current or a previous (historical) session with the orchestration platform 120, to determine what identities, credentials, and the like, were previously used to process workflows with regard to the current user 110. From this historical information, and the information regarding the workflow, agents required to perform the workflow, and tools 140 invoked by the agents 130 (e.g., from the tools catalog 270), the policy engine 240 selects, for each agent 130 involved in performing the workflow, a user identity and credential that provides the minimum required privileges that satisfy the goals of the applicable privilege security policies. That is, the application of the privilege security polices by the policy engine 240 may include performing an optimization on the available identities and credentials of the particular user to select a particular identity, credential, and its corresponding privileges that optimize the weighted goals of the applicable security policies.

The privilege security policies in the policy registry 250 specify which credentials should be preferred when there are a plurality of options. For example, assume that a user has multiple identities, each having a different set of credentials available to it, as follows:

TABLE 1
Example of Multiple Identities and Privileges for a User

| User | Tool | Credential | Identity | Privileges |
|---|---|---|---|---|
| User 1 | Tool 1 | Cred 1 | User 1 | Scope - A, B, C |
| | | | | Expiry - 5 min |
| User 1 | Tool 1 | Cred 2 | Group 1 | Scope - A, B, C, D |
| | | | | Expiry - 10 min |

From the above, it can be seen that user 1 has two different credentials for using tool 1, where credential 1 is an individual user credential and credential 2 is a group credential. The scopes of these credentials overlap and include privileges A, B, C, with credential 2 further comprising privilege D. Credential 1 has an expiry time of 5 minutes for its privileges, whereas credential 2 has an expiry time of 10 minutes for its privileges.

If a workflow calls an agent that invokes tool 1 that requires a privilege A, either credential can provide the necessary privileges to perform the sub-task of that tool. Thus, when there are multiple options available, the policy engine 240 applies the applicable privilege security policies to determine which option to select for a particular invocation of a tool by an agent in a workflow. This may further involve an evaluation of the historical information for the current and/or past sessions. For example, if a privilege security policy has a goal of minimizing the identities used during the flow so as to minimize the number of different identities and their credentials exposed to possible adversaries 190, if the historical information indicates that in the performance of the workflow credential 2 is already used, e.g., an agent/tool required a privilege of D for example, then in order to minimize exposure and avoid exposing credential 1 and the user's individual identity, the policy engine 240 would continue to select credential 2 for subsequent agents/tools in the workflow that require privileges A, B, C, or D. However, if the policy is to minimize the expiry time, then in order to achieve this goal, of the two possible credentials, the policy engine 240 would select credential 1 as it has a shorter expiry time than credential 2 but provides the required privileges.

The application of the policies to the workflow may optimize a variety of different applicable policies using the optimization problem solution logic. In so doing, the optimization may try to optimize the selection to achieve the goals of each of the applicable policies as much as possible, and these goals may be weighted according to priorities of the goals. For example, a user or administrator of the orchestration platform 120 may specify a set of priorities or weights to be applied to one or more workflows of the orchestration platform 120. These priorities or weights may be stored by the policy engine 240 as configuration parameters. Based on the priorities or weights, the various optimization goals may be satisfied. For example, if a priority is minimizing a number of identities, then credential selection may be performed so as to limit the number of identities used by agents and tools so as to minimize those identities to the fewest needed to perform the workflow.

If a priority is minimizing the exposure of scopes of credentials, then a combination of credentials for the agents/tools of the workflow which minimizes the combined scopes of the credentials may be selected, e.g., in the example above, credential 2 would satisfy this criteria as the overlapping scopes of credential 1 and credential 2 is such that credential 2 covers the same scope as credential 1 plus the additional privilege D. If a priority is minimizing expiry time, credentials with the shortest expiry time (and thus the smallest window of possible compromise) may be selected, such as in the example above where credential 1 has the shortest expiry time. If the priority is maximizing the auditability, then credentials that are finest granularity, e.g., individual rather than group credentials, may be selected. It should be appreciated that each of these may have different priorities or weightings and each applicable goal may be evaluated with the policy engine 240 comprising logic to evaluate the balance and optimization of these. Moreover, this logic may further evaluate any other policy enforcement criteria set forth in the privilege security policies applicable to the workflow.

In some illustrative embodiments, the policy engine 240 may calculate an exposure score for a credential based on a weighted sum of the policy goals. For example, there may be a scoring algorithm that weights and sums score values corresponding to the number of identities used, the amount of exposure due to the scopes of the credential, the expiry time of the credential, the auditability of the credential, and other policy enforcement factors. Each of these factors may be scored in accordance with the scoring algorithm and then weighted to generate a weighted sum. The weights may be based on the relative priorities of the factors given by the configuration information of the policy engine 240, which may be different for different users based on their preferences, administrators of the orchestration platform 120, or the like. Based on the weighted sums for a plurality of credentials associated with the user identities of the user 110, a relative ranking of the credentials may be generated and a credential providing the highest/lowest ranking may be selected, for example. That is, for example, the credential providing the lowest number of identities, narrowest scope of privileges, shortest expiry time, greatest auditability, and adherence to other policy enforcement factors may be selected.

After having determined which credentials/privileges should be used and provided to agents required to perform the workflow, the policy engine 240 requests that the identity and authorization flow manager 260 communicate with the appropriate IDPs 180 to acquire the tokens for only the credentials/privileges required by the workflow agents/tools. These tokens are retrieved by the manager 260 using the protocols 262, IDP connectors 264, and data structures 266 from the IDPs 180 and provided to the agents 130. The agents 130 then invoke the tools 140 using the provided tokens. The tools 140 perform their actions on the secure backend 150.

The secure backend system 150 stores logs of the accesses performed on the resources of the secure backend system 150 and these logs store information about the identities and credentials used to perform these operations. For example, in some illustrative embodiments, these logs may include a tuple such as <action, carried_out_by, on_behalf_of>, in which the elements indicate the particular identity and credential of the user (on_behalf_of) used by the agent and tool (carried_out_by) used to perform the action (action). Thus, through the mechanisms of the illustrative embodiments, which minimize the identities and credentials used to perform actions on the secure backend system 150, more narrowly focus these identities and credentials such that the logs maintained by the secure backend system 150 may be more efficiently used to audit the secure backend system 150.

In some illustrative embodiments, it is possible that the selected credentials may not be available to the trust companion 170, e.g., the user 110 may not have provided the credentials during initial registration, the credentials may have expired, or the like. In such a case, these credentials may be requested from the user 110 via their client computing device and the orchestration platform 120. In some illustrative embodiments, if a user's credentials for a particular agent/tool are required, but are not available, the trust companion 170 may instruct the orchestration platform 120 to selected a different agent/tool for the workflow, where the alternative agent/tool preferably provides a similar functionality and is one for which the user has provided the required credentials which are stored in the credentials registry.

Thus, during a setup phase of operation of the trust companion 170, tools 140 and agents 130 are on-boarded to the trust companion 170 by providing the required interfaces for communicating with the agents and providing access to the tools catalog 270 having the metadata about the various available tools 140. It should be appreciated that this on-boarding of tools and agents may also be performed when any new tool or agent is added to the overall system, at which time the agent/tool becomes available for use. The users 110, via the orchestration platform 120, register with the trust companion 170 and login into and connect to the agents 130 and tools 140 using their superset of credentials.

When a user logs into the orchestration platform 120, such as WxO for example, the user provides their credentials for access to various skills, agents, etc. in WxO 120. The user may have a separate set of credentials for various tools 140 or agents 130, such as an employee management system tool used to access an employee management system (secure backend system) 150 which manages the employee personal details, salary information, etc. During the setup phase, the user provides the credentials that can be used to interact with these tools 140 on behalf of the user. For example, the user will provide trust companion computing system 170 access to tokens that can be used to interact with the employee management system 150 on his behalf. The steps for this depend on the protocol followed by the tool 140 (e.g., Oauth, SAML, etc.). Once the trust companion computing system 170 gets the access tokens, they are stored in a credentials database of the trust companion computing system 170 and associated with the user information (see FIG. 2, elements 210 and 220, described hereafter). There are scenarios where a group of users have access to the same set of credentials. For example, a group of people using Human Resources (HR) credentials to manage information in the employee management system may have access to the same set of HR credentials. In this case only one of the users in the group has to provide group credentials for the employee management system 150 to the trust companion 170.

Thus, the user logs into the tools 140 and provides the necessary credentials since the credentials trusted by the tools 140 can be different than the credentials used to log into the orchestration platform 120. This process is infrequent because for the majority of tools 140, the credentials remain valid for long durations of time. On the other hand, during runtime these credentials are used frequently, as and when needed.

During the setup phase of operation, the trust companion 170 captures the identities and super-set of security credentials for each identity used by the user, which is then stored in the user information registry 210 and credentials registry 220. Each user may have multiple identities linked to the same agent/tool, e.g., a user may have an individual identity, a group identity to group 1, a group identity to group 2, an API key, and the like. Each of these identities may have different scopes, where the scope is a set of privileges associated with an identity. The sets of privileges may be part of a credential associated with the user's identity.

During a runtime phase of operation, the orchestration platform 120 determines a workflow that is passed to the agents 130 and the trust companion 170. The trust companion 170 analyzes the workflow to identify the credentials to be used for each tool 140 and agent 130 that is called in the workflow. This may involve interfacing with the agents 130 who select the tools that they will invoke based on the tools catalog 270. The policy engine 240 of the trust companion comprises the intelligent computer logic for selecting the privileges needed for performing the workflow. This may be regarded as an optimization problem with a weighted goal, where the weighted goal may be, for example, minimizing the number of identities used, minimizing the exposure due to scopes of privileges, expiry time of credentials, etc., maximizing the auditability of the workflow, or the like, while taking into account the restrictions and criteria set forth in privilege security policy enforcement. The solution to this optimization problem is a set of credentials, with their corresponding privileges, for each of the agents/tools involved in performing the workflow. These credentials are obtained from the IDPs 180 and are narrowly focused to only a minimal set of credentials/privileges that are needed to perform the actions of the tools 140 invoked by the agents 130 of the workflow and which satisfy the goals of the applicable privilege security policies. The tokens received from the IDPs 180 are provided to the agents 130 which then use these tokens to invoke the corresponding tools 140 in accordance with the workflow. The tools 140 perform actions on the secure backend system 150 which stores logs of these actions for later auditing purposes.

It should be appreciated that the mechanisms of the illustrative embodiments may operate on both static and dynamic workflows. That is, the above description assumes a static workflow in which the entire workflow and its sequence are determined by the orchestration platform 120 prior to executing the workflow. However, in other illustrative embodiments, the workflow may be dynamic, meaning that agents 130 may decide the next steps in a workflow dynamically based on a current state of the workflow. That is, once an agent 130 performs its sub-task using the tool(s) invoked by that agent 130, based on the results of the performance of that sub-task, the agent 130, in a mid-workflow step, may choose the next agent/tool to be used to continue the workflow. Thus, the above processes may be performed dynamically at each agent 130 while the workflow is being executed.

Thus, the illustrative embodiments provide an improved computing tool and improved computing tool operations/functionality to provide oversight support for an orchestration platform to carry out provisioning of different privileges for different agents and skills/tools. The illustrative embodiments further provide oversight support for an orchestration platform to carry out analysis of required privileges for a workflow composed of agent and tool actions by taking into account required privileges for different steps of the workflow. The illustrative embodiments implement operations/functionality to infer and grant the least privileges required to execute the individual steps and complete the workflow. The illustrative embodiments minimize the exposure across different valid combinations of tokens taking into account factors such as the number of tokens, lead time to expiry, and the like. The illustrative embodiments provide operations/functionality to grant the tokens so as to enable trusted backends to independent drive the audit trail of actions in the form of <action, carried_out_by, on_behalf_of>, or the like. The illustrative embodiments provide operations/functionality to enforce access and privilege compliance given access to the organizational policy engines.

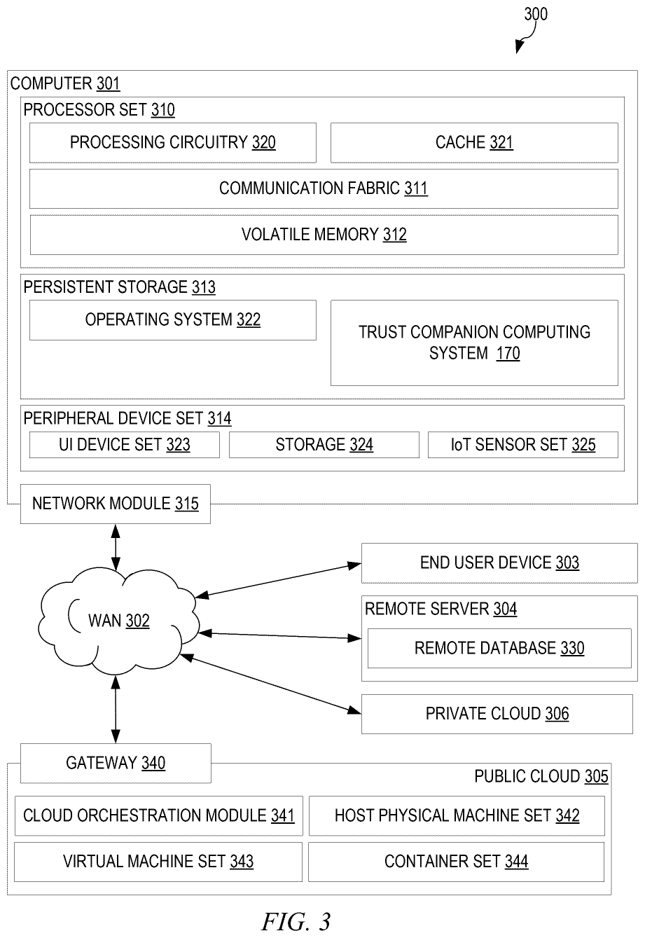

FIG. 3 is an example diagram of a distributed data processing system environment in which aspects of the illustrative embodiments may be implemented and at least some of the computer code involved in performing the inventive methods may be executed. That is, computing environment 300 contains an example of an environment for the execution of at least some of the computer code involved in performing the inventive methods, such as trust companion 170. In addition to trust companion 170, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and trust companion 170, as identified above), peripheral device set 314 (including user interface (UI), device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

Computer 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

Processor set 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in trust companion 170 in persistent storage 313.

Communication fabric 311 is the signal conduction paths that allow the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 312 is any type of volatile memory now known or to be developed in the future. Examples include dynamic type random access memory (RAM) or static type RAM. Typically, the volatile memory is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

Persistent storage 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface type operating systems that employ a kernel. The code included in trust companion 170 typically includes at least some of the computer code involved in performing the inventive methods.

Peripheral device set 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

Network module 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 303 is any computer system that is used and controlled by an end user (for example, a customer of an enterprise that operates computer 301), and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

As shown in FIG. 3, one or more of the computing devices, e.g., computer 301 or remote server 304, may be specifically configured to implement a trust companion 170. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 301 or remote server 304, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described herein, the implementation of the mechanisms of the illustrative embodiments improves the functionality of the computing device and provides a useful and concrete result that facilitates workflow executions via agents/skills and invoked tools while minimizing exposure of privileges to the tools and potentially adversaries that gain access to these tools. In this way, the scope of the unauthorized access and possible actions executed by such an adversary may be narrowed and minimized.

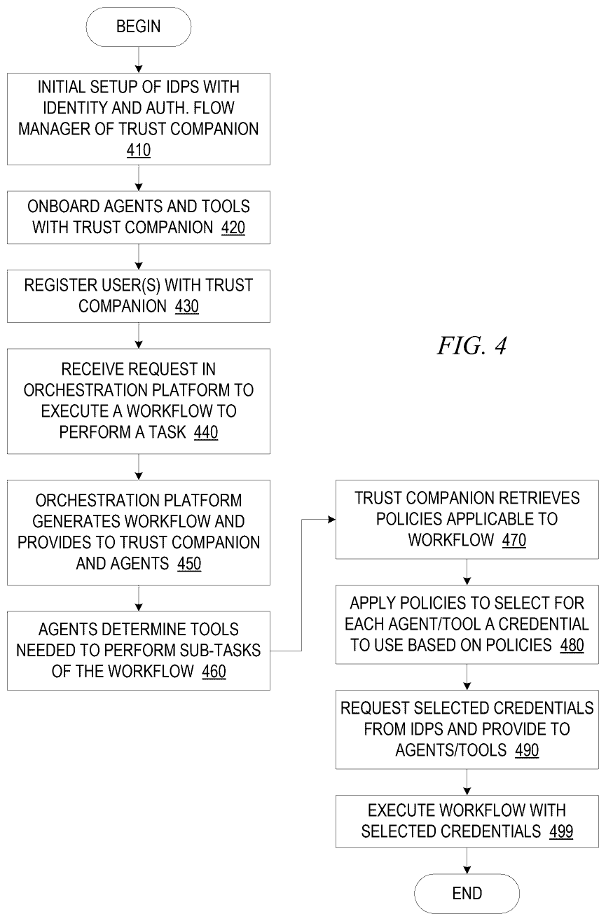

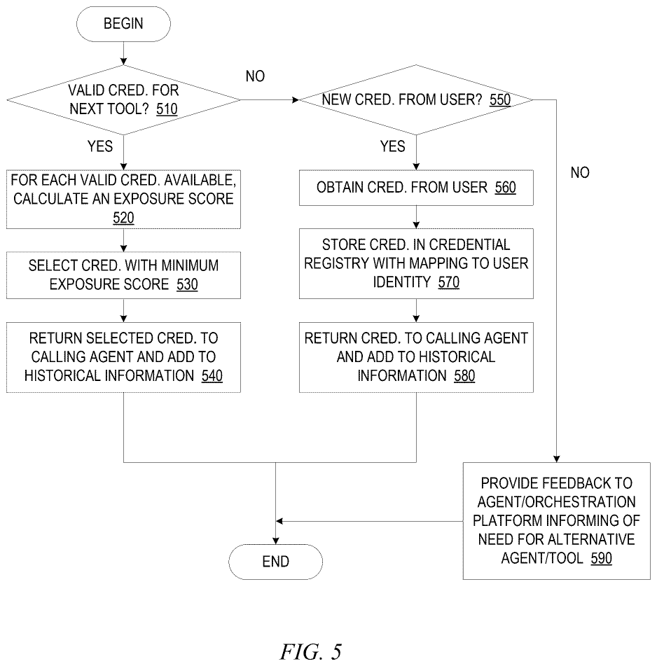

FIGS. 4-5 present flowcharts outlining example operations of elements of the present invention with regard to one or more illustrative embodiments. It should be appreciated that the operations outlined in FIGS. 4-5 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIGS. 4-5, and may, in some cases, make use of the results generated as a consequence of the operations set forth in FIGS. 4-5, the operations in FIGS. 4-5 themselves are specifically performed by the improved computing tool in an automated manner.

FIG. 4 is a flowchart outlining an example operation of a trusted companion system in accordance with one illustrative embodiment. As shown in FIG. 4, the operation starts with an initial setup of the IDPs with the identity and authorization flow manager of the trust companion (step 410). In addition, the agents and tools are onboarded with the trust companion (step 420) and one or more users register with the trust companion by logging into the orchestration platform and each tool that has been onboarded and provides the credentials and superset of privileges (step 430). It should be appreciated that steps 410-430 are part of a setup phase of operation and are performed infrequently. Steps 440 and thereafter are part of a runtime phase of operation and are performed more frequently.

Thereafter, a user logs into the orchestration platform and requests that the orchestration platform execute a workflow to perform a specified task (step 440). The orchestration platform generates the workflow and provides the workflow to the trust companion and the agents that will execute the workflow (step 450). The agents determine what tools are needed to perform the requested sub-tasks of the workflow and this information is provided to the trust companion (step 460). The trust companion retrieves the privilege security policies applicable to the workflow (step 470) and applies these policies to the identities and credentials associated with the user to select, for each agent/tool, a credential to be used for that agent/tool which minimizes exposure of privileges and satisfies the goal(s) of the applicable privilege security policies (step 480). The selected credentials are requested from appropriate IDPs and the resulting tokens are provided to the agents/tools for use in performing the actions of the workflow (step 490). If the selected credentials for the tool has expired, or is not available, then either the user will need to login to the tool to obtain superset credentials, stored in a credentials database, down-scoped to least privilege, or feedback is provided to the orchestration platform that the tool is not available. Assuming that the credentials are not expired and available, the workflow is then executed by the agents/tools using the supplied credentials (step 499). The operation then terminates.

FIG. 5 is a flowchart outlining an example operation for dynamic credential selection in accordance with one illustrative embodiment. As noted above, the operations of the illustrative embodiments may be used both with static and dynamic workflows. In the case of dynamic workflows, at each agent along the workflow, the agent may call the trust companion to request the credential to be used to invoke a corresponding tool. Thus, the credentials may be selected dynamically by the trust companion. FIG. 5 is an example flowchart outlining an example operation for performing such a dynamic selection of a credential on an agent-by-agent basis for the tools invoked by those agents.

As shown in FIG. 5, the operation starts by determining if a valid credential for a next tool to be invoked is available or not (step 510). If so, then for each valid credential available, an exposure score may be calculated, such as in the manner previously described above using a weighted sum or other suitable function (step 520). A credential with a minimum exposure score may then be selected from the available credentials (step 530) and returned to the calling agent as well as added to the historical information in the logging database (step 540). If a valid credential for a next tool is not available, a determination may be made as to whether a new valid credential can be obtained from the user (step 550). If so, the credential is obtained from the user (step 560), stored in the credentials registry with a mapping to the user identity (step 570), and the credential is returned to the calling agent and added to the historical information (step 580). If a valid credential cannot be obtained from the user, then feedback may be provided back to the agent and/or orchestration platform to inform the agent/platform of the need to find an alternative agent/tool (step 590). The operation then terminates.

Thus, the illustrative embodiments provide an improved computing tool and improved computing tool operations/functionality that provide an automated and autonomous trust companion for determining a minimized exposure of privileges that accomplishes the tasks of a workflow and limits potential misuse of credentials by unauthorized adversaries. The illustrative embodiments further improve audit capabilities by providing more fine grain and limited credentials and privileges as much as possible, and providing credentials tied to users as much as possible, which improves the specific with which audits may identify the parties involved in performing actions on the secure backend resources. Thus, the illustrative embodiments improve security of workflow executions via orchestration platform pathways using agents/skills and invoked tools.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving, by a trust companion computing system, from an orchestration platform, a one or more workflow portions of a workflow for performing a task, wherein the one or more workflow portions comprise one or more entities that invoke one or more tools to perform sub-tasks of the task;
for each tool in the one or more tools:
determining, by the trust companion computing system, a corresponding credential to be used to invoke the tool to perform an action on secure backend resources, wherein the corresponding credential corresponds to a reduced size set of one or more privileges, less than a superset of privileges, that are used to perform the action; and
requesting, by the trust companion computing system, from one or more identity providers, a token that provides only the credential having the reduced size set of one or more privileges; and
providing, by the trust companion computing system to the one or more entities, the tokens for each tool in the one or more tools; and
recording, by a secure backend system associated with the one or more tools, tokens used to execute the one or more workflow portions by the one or more tools, for provenance and auditing.

2. The method of claim 1, wherein determining the corresponding credential comprises applying one or more privilege security policies to the workflow, wherein the one or more privilege security policies comprise goals specifying a metric for minimizing exposure of privileges when invoking tools for performing the workflow.

3. The method of claim 2, wherein the one or more privilege security policies comprises at least one of:
a first privilege security policy that minimizes a number of identities of a user used to invoke tools for performing the workflow,
a second privilege security policy that minimizes a scope of privileges of the credentials used to invoke tools for performing the workflow,
a third privilege security policy that minimizes expiry time of privileges of the credentials used to invoke tools for performing the workflow, or
a fourth privilege security policy that maximizes an auditability of logs of actions performed by the tools when performing the workflow.

4. The method of claim 1, wherein determining the corresponding credential comprises:
generating, for each available credential for a user, an exposure score that measures a degree of exposure of privileges associated with the credential; and
selecting a credential from the available credentials for the user based on the exposure scores for each available credential for the user.

5. The method of claim 4, wherein the exposure score is generated based on a function of a plurality of factors and a plurality of weights applied to the plurality of factors, wherein the factors comprise at least one of a number of identities used by the credential, an exposure due to scopes of privileges associated with the credential, an expiry time associated with the credential, or an auditability of the credential.

6. The method of claim 1, wherein the one or more entities execute the workflow using the one or more tools and the tokens provided to the one or more entities.

7. The method of claim 1, wherein the one or more entities are language model backed agents that autonomously perform corresponding tasks, leveraging natural language understanding and generation, and which communicate with other language model backed agents in the one or more entities to achieve specific sub-tasks of the workflow.

8. A computer program product comprising:
one or more computer-readable storage media; and
program instructions stored on the one or more computer-readable storage media to perform operations comprising:
receiving, by a trust companion computing system, from an orchestration platform, one or more workflow portions of a workflow for performing a task, wherein the one or more workflow portions comprise one or more entities that invoke one or more tools to perform sub-tasks of the task;
for each tool in the one or more tools:
determining, by the trust companion computing system, a corresponding credential to be used to invoke the tool to perform an action on secure backend resources, wherein the corresponding credential corresponds to a reduced size set of one or more privileges, less than a superset of privileges, that are used to perform the action; and
requesting, by the trust companion computing system, from one or more identity providers, a token that provides only the credential having the reduced size set of one or more privileges; and
providing, by the trust companion computing system to the one or more entities, the tokens for each tool in the one or more tools; and
recording, by a secure backend system associated with the one or more tools, tokens used to execute the one or more workflow portions by the one or more tools, for provenance and auditing.

9. The computer program product of claim 8, wherein determining the corresponding credential comprises applying one or more privilege security policies to the workflow, wherein the one or more privilege security policies comprise goals specifying a metric for minimizing exposure of privileges when invoking tools for performing the workflow.

10. The computer program product of claim 9, wherein the one or more privilege security policies comprises at least one of:
a first privilege security policy that minimizes a number of identities of a user used to invoke tools for performing the workflow,
a second privilege security policy that minimizes a scope of privileges of the credentials used to invoke tools for performing the workflow,
a third privilege security policy that minimizes expiry time of privileges of the credentials used to invoke tools for performing the workflow, or
a fourth privilege security policy that maximizes an auditability of logs of actions performed by the tools when performing the workflow.

11. The computer program product of claim 8, wherein determining the corresponding credential comprises:
generating, for each available credential for a user, an exposure score that measures a degree of exposure of privileges associated with the credential; and
selecting a credential from the available credentials for the user based on the exposure scores for each available credential for the user.

12. The computer program product of claim 11, wherein the exposure score is generated based on a function of a plurality of factors and a plurality of weights applied to the plurality of factors, wherein the factors comprise at least one of a number of identities used by the credential, an exposure due to scopes of privileges associated with the credential, an expiry time associated with the credential, or an auditability of the credential.

13. The computer program product of claim 8, wherein the one or more entities execute the workflow using the one or more tools and the tokens provided to the one or more entities.

14. The computer program product of claim 8, wherein the one or more entities are language model backed agents that autonomously perform corresponding tasks, leveraging natural language understanding and generation, and which communicate with other language model backed agents in the one or more entities to achieve specific sub-tasks of the workflow.

15. A computer system comprising:
a processor set;
one or more computer-readable storage media; and
program instructions stored on the one or more computer-readable storage media to cause the processor set to perform operations comprising:
receiving, by a trust companion computing system, from an orchestration platform, one or more workflow portions of a workflow for performing a task, wherein the one or more workflow portions comprise one or more entities that invoke one or more tools to perform sub-tasks of the task;
for each tool in the one or more tools:
determining, by the trust companion computing system, a corresponding credential to be used to invoke the tool to perform an action on secure backend resources, wherein the corresponding credential corresponds to a reduced size set of one or more privileges, less than a superset of privileges, that are used to perform the action; and
requesting, by the trust companion computing system, from one or more identity providers, a token that provides only the credential having the reduced size set of one or more privileges; and
providing, by the trust companion computing system to the one or more entities, the tokens for each tool in the one or more tools; and
recording, by a secure backend system associated with the one or more tools, tokens used to execute the one or more workflow portions by the one or more tools, for provenance and auditing.

16. The computer system of claim 15, wherein determining the corresponding credential comprises applying one or more privilege security policies to the workflow, wherein the one or more privilege security policies comprise goals specifying a metric for minimizing exposure of privileges when invoking tools for performing the workflow.

17. The computer system of claim 16, wherein the one or more privilege security policies comprises at least one of:
a first privilege security policy that minimizes a number of identities of a user used to invoke tools for performing the workflow,
a second privilege security policy that minimizes a scope of privileges of the credentials used to invoke tools for performing the workflow,
a third privilege security policy that minimizes expiry time of privileges of the credentials used to invoke tools for performing the workflow, or
a fourth privilege security policy that maximizes an auditability of logs of actions performed by the tools when performing the workflow.

18. The computer system of claim 15, wherein determining the corresponding credential comprises:
generating, for each available credential for a user, an exposure score that measures a degree of exposure of privileges associated with the credential; and
selecting a credential from the available credentials for the user based on the exposure scores for each available credential for the user.

19. The computer system of claim 18, wherein the exposure score is generated based on a function of a plurality of factors and a plurality of weights applied to the plurality of factors, wherein the factors comprise at least one of a number of identities used by the credential, an exposure due to scopes of privileges associated with the credential, an expiry time associated with the credential, or an auditability of the credential.

20. The computer system of claim 15, wherein the one or more entities execute the workflow using the one or more tools and the tokens provided to the one or more entities.
